(19) United States
(12) Patent Application Publication
(10) Pub. No.: US 2016/0099985 A1
(43) Pub. Date: Apr. 7, 2016

(54) Combination of Unicast and Multicast User Plane Data

(71) Applicant: Nokia Solutions and Networks Oy, Espoo (FI)

(72) Inventors: Henri Markus Koskinen, Espoo (FI); karri Markus Ranta-aho, Espoo (FI); Antti Jaakko Pasanen, Helsinki (FI)

(21) Appl. No.: 14/889,542

(22) PCT Filed: May 9, 2013
(86) PCT No.: PCT/IB2013/053762

§ 371 Date: Nov. 6, 2015

(51) Int. Cl. H04L 29/06; H04W 24/08; H04W 4/06

(52) U.S. Cl. CPC H04L 65/403; H04W 4/06; H04W 24/08

(57) ABSTRACT

User plane data is communicated by cell-specific broadcasting of said user plane data in a cell and unicasting in parallel the same user plane data to at least one communication device participating a group service. When receiving the user plane data, a communication device receiving the eel- specific broadcasting and unicasting can combine the broadcast and unicast user plane data.

This disclosure relates to communications of user plane data in a cellular system.

A communication system can be seen as a facility that enables communications between two or more nodes such as fixed or mobile communication devices, access points such as base stations, servers and so on. A communication system and compatible communicating entities typically operate in accordance with a given standard or specification which sets out what the various entities associated with the system are permitted to do and how that should be achieved. For example, the standards, specifications and related protocols can define the manner how communication devices shall communicate with the access points, how various aspects of the communications shall be implemented and how the equipment shall be configured.

Signals can be carried on wired or wireless carriers. Examples of wireless systems include public land mobile networks (PLMN) such as cellular networks, satellite based communication systems and different wireless local networks, for example wireless local area networks (WLAN). Wireless systems can be divided into coverage areas referred to as cells, and hence the wireless systems are often referred to as cellular systems. A cell can be provided by a base station, there being various different types of base stations and cells.

A user can access the communication system by means of an appropriate communication device or terminal. A communication device is provided with an appropriate signal receiving and transmitting arrangement for enabling communications with other parties. Typically a communication device is used for enabling receiving and transmission of communications such as voice, images, video and other data. A communication device of a user is often referred to as a user equipment (UE).

Various communication application and services are available for the users. An example of these is group services where communications between a plurality of users can be can be provided by means of a group communication system providing a group service. The possibility of being able to communicate voice, image and video data with a group of users on site is considered as an important aspect for example in various public-safety applications. A typical service envisioned in this context is a voice group call with possibly a large number of participants per cell at an incident location. It shall be understood that this is only an example and other uses are also contemplated. User plane data delivered by a group service can be used, for example for surveillance applications, for improving situation awareness during critical missions and/or for improving co-operation between different groups and teams involved e.g. in response to a natural disaster or accident or other unexpected incident. For example, officials such as police officers, fire-fighters, ambulance crews and other emergency workers would prefer to have a fast and reliable communication system at their disposal in an emergency situation.

An envisaged requirement for a group communication system is that it should support various media such as voice, video or data (e.g. messaging or supplementary data like maps) in any combination. Another requirement is that when UEs are moving among cells during a group communication session, service continuity should be supported. The evolved packet system (EPS) should provide a mechanism to efficiently distribute data for group communication. The number of group members in any area may be unlimited. Infinite scalability has thus also been proposed. Because of this, broadcast transmission is considered beneficial for the downlink delivery of communications such as the group-call voice. In a current framework this would mean using Multicast Broadcast Multimedia Service (MBMS). However, MBMS has been developed with a different use case in mind, namely blind broadcasting of TV-like streaming service to a well pre-defined and pre-configured area. The currently specified MBMS is based on MBSFN single-frequency-network broadcast where adjacent cells are tightly synchronized to broadcast identical content on the same centrally pre-configured time-frequency resources. Because of this the broadcast appears to the receiving terminal as multi-path components of a single transmission. Because of this, MBMS transmission is currently only specified in specific MBSFN subframes allowing only transmission of the MBMS broadcast.

Furthermore, delivery of a voice group call which may only involve delivering a small data packet e.g. every 20 ms to given UEs located in given cells (that are not necessarily adjacent) also has issues. Currently radio access network (RAN) nodes are not continuously kept aware of which broadcast service is being received by which UE. Therefore the broadcast will likely need to take place also in cells other than where the UEs currently are as otherwise a UE moving from a cell currently broadcasting to a cell not yet broadcasting is likely to lose the service at least momentarily. This would not satisfy the service continuity requirement. Also, use of a complete subframe even to broadcast a small voice packet is very inefficient use of radio resources.

It is noted that the above discussed issues are not limited to any particular communication environment and apparatus but may occur in any appropriate system where cell-specific broadcasting of user plane data for a group service may be provided.

Embodiments of the invention aim to address one or several of the above issues.

In accordance with an embodiment there is provided a method of communicating user plane data for group service, the method comprising causing cell-specific broadcasting of said user plane data in a cell, and unicasting in parallel the same user plane data to at least one communication device in the cell.

In accordance with an embodiment there is provided a method of receiving user plane data by a communication device participating a group service, the method comprising receiving cell-specific broadcasting of said user plane data in a cell, receiving in parallel unicasting of said user plane data, and combining the broadcast and unicast user plane data.

In accordance with an embodiment there is provided a control apparatus for a cell, the control apparatus comprising at least one processor, and at least one memory including computer program code, wherein the at least one memory and the computer program code are configured, with the at least one processor, to cause cell-specific broadcasting of user plane data for a group service in a cell, and parallel unicasting of the same user plane data to at least one communication device in the cell.

In accordance with an embodiment there is provided a control apparatus for a communication device, the control apparatus comprising at least one processor, and at least one memory including computer program code, wherein the at least one memory and the computer program code are configured, with the at least one processor, to cause reception of cell-specific broadcasting of user plane data for a group service in a cell, parallel reception of unicasting of the same user plane data, and combining the broadcast and unicast user plane data.

In accordance with a more detailed embodiment at least one of selective combining and soft combining of broadcast and unicast user plane data is provided.

The user plane data may comprise voice and/or video data.

The unicasting may be directed to or received by at least one communication device in poor radio conditions.

The user plane data may be broadcast only in a part of the area of the cell whilst other area of the cell is covered by the unicasting.

At least one communication device may be configured by a radio resource control procedure to monitor a physical downlink control channel for communications associated with cell-specific broadcasting based on a radio network temporary identifier allocated for the group service and to monitor the physical downlink control channel for downlink allocations associated with the service based on a cell and device specific radio network temporary identifier.

It may be continuously determined whether to transmit a given data packet of said user plane data to a given communication device by broadcasting and/or by unicasting based on information of at least one of the number of communication devices in the cell, channel quality reported from the cell and error correction mechanism feedback in control of said communication of user plane data and/or at least one report from at least one communication device.

An activation command or deactivation command may be by used a network node and a communication device in control of monitoring a radio network temporary identifier allocated for a group service.

A cell-specific broadcasting may be provided based on a cell-specific discontinuous reception scheme.

A communication device may determine that decoding of a data packet corresponding to a detected radio network temporary identifier associated with the broadcasting was unsuccessful, and signal a negative acknowledgement in response to said determining of unsuccessful decoding of the broadcast data packet. At least two communication devices may signal negative acknowledgements such that a stronger negative acknowledgement signal is generated compared to a single negative acknowledgement.

A computer program comprising program code means adapted to perform the herein described methods may also be provided. In accordance with further embodiments apparatus and/or computer program product that can be embodied on a computer readable medium for providing at least one of the above methods is provided.

A network node such as a base station or a controller associated with one or more cells can be configured to operate in accordance with the various embodiments. A communication device wherein the embodiments are implemented may also be provided. A communication system embodying the apparatus and principles of the invention may also be provided.

It should be appreciated that any feature of any aspect may be combined with any other feature of any other aspect.

Embodiments will now be described in further detail, by way of example only, with reference to the following examples and accompanying drawings, in which:

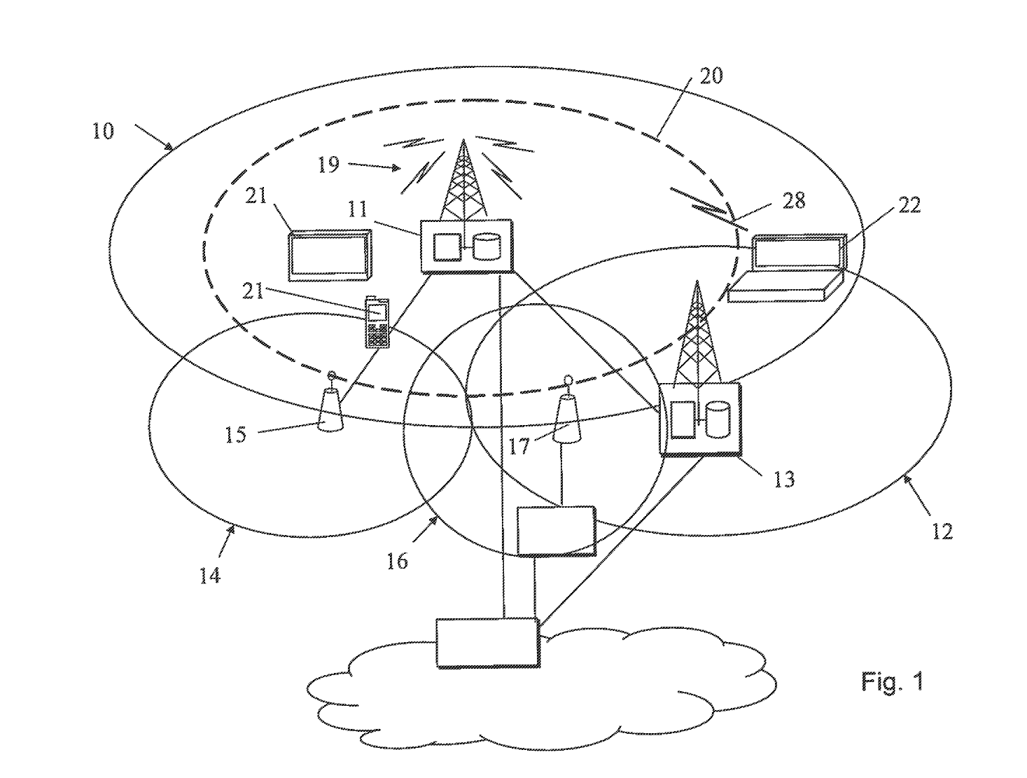

FIG. 1 shows a schematic diagram of a cellular system where certain embodiments can be implemented;

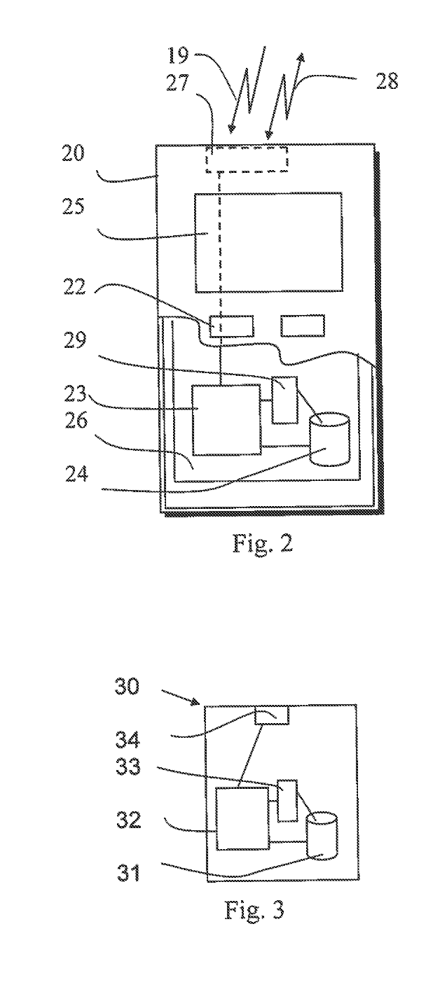

FIG. 2 shows an example of a communication device;

FIG. 3 shows an example of control apparatus for a cell; and

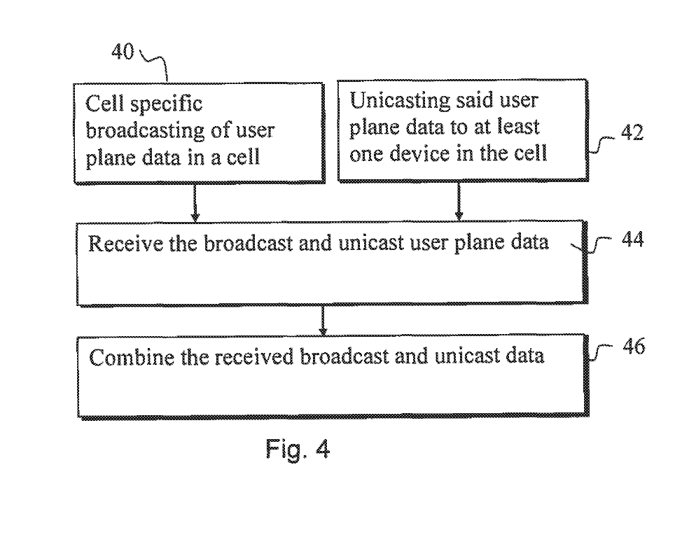

FIG. 4 shows a flowchart according to a certain embodiment.

In the following certain exemplifying embodiments are explained with reference to a wireless or mobile communication system serving mobile communication devices. Before explaining in detail the exemplifying embodiments, certain general principles of a wireless communication system, access systems thereof, and mobile communication devices are briefly explained with reference to FIGS. 1 to 3 to assist in understanding the technology underlying the described examples.

A non-limiting example of the recent developments in cellular communication system architectures is the long-term evolution (LTE) of the Universal Mobile Telecommunications System (UMTS) that is being standardized by the 3rd Generation Partnership Project (3GPP). The LTE employs a mobile architecture known as the Evolved Universal Terrestrial Radio Access Network (E-UTRAN). Base stations of such systems are known as evolved or enhanced Node Bs (eNodeB; eNB) and may provide E-UTRAN features such as user plane Radio Link Control/Medium Access Control/Physical layer protocol (RLC/MAC/PHY) and control plane Radio Resource Control (RRC) protocol terminations towards communication devices. An eNodeB can provide coverage for an entire cell or similar radio service area. Other examples of radio access system include those provided by base stations of systems that are based on technologies such as wireless local area network (WLAN) and/or WiMax (Worldwide Interoperability for Microwave Access). WLANs are sometimes referred to by WiFi™, a trademark that is owned by the Wi-Fi Alliance, a trade association promoting Wireless LAN technology and certifying products conforming to certain standards of interoperability.

Communication devices or terminals can be provided wireless access via base stations or similar wireless transmitter and/or receiver nodes providing radio service areas or cells. In FIG. 1 a plurality of different cells 10, 12, 14 and 16 are shown being provided by base stations 11, 13, 15 and 17, respectively. The communication devices 21 and 22 may comprise any suitable device capable of wireless communication of data.

It is noted that the number of cells and their borders are shown schematically for illustration purposes only in FIG. 1. Thus it shall be appreciated that the number, size and shape of the cells may vary considerably from those shown in FIG. 1. A base station site can provide one or more cells or sectors. A sector may provide a cell or a subarea of a cell.

Base stations are typically controlled by at least one appropriate controller apparatus so as to enable operation thereof and management of mobile communication devices in communication with the base stations. The control apparatus can be interconnected with other control entities. The control apparatus can typically be provided with memory capacity and at least one data processor. The control apparatus and functions may be distributed between a plurality of control units. In some embodiments, each base station can comprise a control apparatus. In alternative embodiments, two or more base stations may share a control apparatus. In some embodiments the control apparatus may be respectively provided in each base station.

FIG. 2 shows a schematic, partially sectioned view of a communication device 20 that can be employed in the herein described examples. Such a communication device is often referred to as user equipment (UE) or terminal. An appropriate mobile communication device may be provided by any device capable of sending and receiving radio signals. Non-limiting examples include a mobile station (MS) such as a mobile phone or what is known as a ‘smart phone’, a portable computer such as a laptop or a tablet computer provided with a wireless interface card or other wireless interface facility, personal data assistant (PDA) provided with wireless communication capabilities, or any combinations of these or the like. A mobile communication device may provide, for example, communication of data for carrying communications such as voice, electronic mail (email), text message, multimedia (images, audio and video), positioning data, other data, and so on. Users may thus be offered and provided numerous services via their communication devices. Non-limiting examples of these services include two-way or multi-way calls, data communication or multimedia services or simply an access to a data communications network system, such as the Internet.

A mobile device is typically provided with at least one data processing entity 23, at least one memory 24 and other possible components 29 for use in software and hardware aided execution of tasks it is designed to perform, including control of access to and communications with base stations and other communication devices. The data processing, storage and other relevant control apparatus can be provided on an appropriate circuit board and/or in chipsets. This feature is denoted by reference 26. Data processing and memory functions provided by the control apparatus of the mobile device to cause control and signalling operations in accordance with certain embodiments of the present invention will be described later in this description.

The user may control the operation of the mobile device by means of a suitable user interface such as key pad 22, voice commands, touch sensitive screen or pad, combinations thereof or the like. A display 25, a speaker and a microphone are also typically provided. A still and/or video camera may also be provided. Furthermore, a mobile communication device may comprise appropriate connectors (either wired or wireless) to other devices and/or for connecting external accessories, for example hands-free equipment, thereto.

The mobile device may receive and transmit dedicated signals 28 by the base station 11 of FIG. 1 via appropriate apparatus for receiving and transmitting signals. Also, the mobile device can receive broadcast signals 19 by base station 11 of FIG. 1. In FIG. 2 the transceiver apparatus is designated schematically by block 27. The transceiver may be provided for example by means of a radio part and associated antenna arrangement. The antenna arrangement may be arranged internally or externally to the mobile device. A wireless communication device can be provided with a Multiple Input/Multiple Output (MIMO) antenna system.

FIG. 3 shows an example of a control apparatus 30, for example to be integrated with, coupled to and/or otherwise arranged for controlling at least one of the cells of FIG. 1. The control apparatus 30 can be arranged to provide control on communications in the service area of a single cell or a plurality of cells. The control apparatus 30 can be configured to provide control functions in association with group data communications, such as in the case of emergency (e.g. major accidents, natural disasters, and so forth) and for reasons of public safety or state security in accordance with certain embodiments described below. For this purpose the control apparatus comprises at least one memory 31, at least one data processing unit 32, 33 and an input/output interface 34. Via the interface the control apparatus can be coupled to a receiver and a transmitter of the base station. The control apparatus can be configured to execute an appropriate software code to provide the control functions. It shall be appreciated that similar component can be provided in a control apparatus provided elsewhere in the system for controlling reception of sufficient information for decoding of received information blocks.

FIG. 1 shows three communication devices 21 and 22 within the area of cell 10. Base station 11 of cell 10 transmits a broadcast of data 19. The broadcasting is arranged such that it is ensured that devices 21 within area denoted by dashed line 20 receive it properly. However, mobile device 22 although within cell 10 is outside of this area.

As discussed earlier, group communications that are based on broadcasting can present somewhat contradicting requirements such as scalability, service continuity and radio resource efficiency. A cell-specific broadcast mode instead of single-frequency-network based broadcast mode for user-plane transmission can be used to address this issue. However, this approach can lack the single-frequency-network gain where neighbour-cell interference is turned into useful signal power. Also, utilization of information on channel conditions of the receiving terminals may not be possible. The spectral efficiency of making cell-specific broadcast receivable all the way to cell edge can become comparable to that of the current system-information broadcast and be costly in terms of radio resources. This is turn can mean that such a blind broadcast transmission made robust enough may not be efficient enough to be able to carry e.g. video media to a cell edge location or elsewhere where the quality of the cell-specific broadcast cannot be guaranteed without excessive use of resources.

Efficiency can be improved by tuning broadcast transmission 19 to some reasonable level where the whole cell is not covered but most terminals are nevertheless reached. This is shown by area 20 in FIG. 1. Terminal 22 outside the area, e.g. at cell edge, can then use unicast transmission 28. The unicasting can be provided with sophisticated features of e.g. the LTE such as channel quality indicator (CQI) and hybrid automatic repeat request (HARQ) feedback. However, use of unicasting as a purely alternative transmission mode can result in worsening dynamics as the base station may need to perform transmission-mode switches on individual terminals. Also, a need to define the corresponding procedures as e.g. in UTRAN Multicast Broadcast Multimedia Service (MBMS) may arise.

FIG. 4 shows a flowchart for operation in accordance with an example. A controller of at least one cell controls communications of user plane data by a group service to communication devices within a cell such that at step 40 cell-specific broadcasting of said user plane data is caused in the at least one cell. At the same time same user plane data is unicast at 42 to at least one communication device in the cell.

FIG. 4 also shows the operation at a receiving device participating the group service. The cell specific broadcasting of the user plane data is received at 44 substantially at the same with reception of the same data via unicasting. The broadcast and unicast user plane data is then combined at 46 into a single stream of packets. By means of this kind of operation the benefits of cell specific broadcasting coupled with those of unicast transmission are achieved.

In accordance with an embodiment cell-specific broadcasting is used instead of single frequency network based broadcasting by supplementing the cell-specific broadcast transmission by unicast transmission. This is provided to ensure reliable communication also for users who are located e.g. at the cell edge or otherwise have poor radio conditions and may not properly receive the cell-specific broadcasting.

Simultaneously received broadcast and unicast in the same cell can be combined by the receiving devices based on an appropriate combining technique.

In accordance with a more detailed example communication devices in a cell are configured by radio resource control (RRC) to receive cell-specific broadcast transmission and in parallel a dedicated radio bearer. The cell-specific broadcast transmission can be received by monitoring on physical downlink control channel (PDCCH) a Radio Network Temporary Identifier (RNTI) allocated for the purpose. This operation can be seen as resembling monitoring for system information RNTI (SI-RNTI) to receive System-information blocks or paging RNTI (P-RNTI) to receive paging. In parallel, a conventional dedicated radio bearer that has been configured by radio resource control (RRC) can be received and associated to this group service by the communication device monitoring on physical downlink control channel (PDCCH) for downlink allocations. This can be based on the cell RNTI (C-RNTI) of the communication device that has been allocated to it by the cell for the RRC connection. This C-RNTI may also be used for delivery of any user-specific services and signalling.

The operation can be controlled by a controller such as an eNB. The eNB can continuously take into account factors such as the number of devices in a cell receiving the service, each device's CQI reports and so on when deciding whether to transmit a given packet for the service by cell-specific broadcast transmission or for some or all of the devices on dedicated radio bearers. In the latter case e.g. error correction mechanism feedback, such as hybrid automatic repeat request (HARQ) ACK/NACK ([positive] acknowledgement/negative acknowledgement) feedback may be utilised.

In some cases the most radio-efficient way can be simply to use only dedicated radio bearers for the data delivery. This may be the case e.g. when there is only a couple of communication devices in a cell receiving the group service. For such cases, an activation/deactivation command (most likely in the form of medium access control (MAC) control element(s)) may be provided to control whether or not the receiving devices currently need to monitor the RNTI for broadcast transmission. This can be provided analogously to existing activation/deactivation commands that are currently specified to control whether a carrier-aggregation capable device needs to monitor serving cells other than its primary serving cell.

In accordance with an example a communication device is configured for selective combining between unicast and broadcast transmission from the same cell. In accordance with the principles of selective combining, the communication device combines packets received over these two separate logical channels, and discards duplicates from successful reception from both channels, based on packet numbers, at Radio Link Control (RLC) protocol, or at some higher-layer protocol. The protocol can be run in unacknowledged mode.

A communication device specific discontinuous reception (DRX) operation can be used to facilitate good battery life of the device for unicast content. In this type of operation the communication device needs only to check a sub-set of downlink subframes for its C-RNTI. To keep the benefits of DRX, the broadcast RNTI can define a cell-specific DRX parameterization that is common to all communication devices interested in the cell-specific broadcast content. The DRX parameterization means that for one set of subframes the communication device would check for C-RNTI, and for another set of subframes the broadcast RNTI, and it would be able to sleep for the remainder of subframes. Should the active period of the two DRX cycles fall on the same subframes the communication device then should check for both RNTIs in those subframes.

For reception of data on broadcast RNTI, the communication device can be configured to transmit acknowledgements only in the case of unsuccessful reception. I.e. if the communication device detects the broadcast RNTI, and the corresponding downlink (DL) packet does not decode correctly the communication device responds with NACK. If the packet decoded correctly the communication device does not need to respond with ACK. A benefit of this type of operation is that the eNB can retransmit the packet if it sees one NACK. The retransmission can take place over broadcasting or unicasting, or both, if deemed appropriate.

In accordance with an embodiment the resource in which the NACK is transmitted is a common resource to all UEs in such a way that if multiple UEs transmit NACK the signal would be seen as a stronger signal in the eNB. The NACK transmission can be defined such that even though the NACK transmissions may originate from different UEs on the same radio resource these transmissions do not interfere with each other but rather reinforce each other. However, UE's dedicated ACK/NACK resource can be utilized as well. In this option the eNB can identify the UE sending the NACK.

Combining two given transmissions that cannot be independently decoded without error can make it possible to obtain enough information to correctly decode the data. In above a reference was made to selective combining where two signals are received. In selective combining the receiving device can attempt to decode both receptions and then discards duplicates if both succeed. Another example of combining methods include soft combining. A form of soft combining is chase combining. In chase combining every retransmission contains the same information (data and parity bits). The receiver uses maximum-ratio combining to combine the received bits with the same bits from the transmissions. As the transmissions are identical chase combining can be seen as additional repetition coding. Incremental redundancy is another form of soft combining. In incremental redundancy every transmission contains different information. Multiple sets of coded bits are generated, each representing the same set of information bits. The supplementing, or second, transmission of the same user plane data can use a different set of coded bits than the main, or first, transmission, with different redundancy versions generated by puncturing the decoder output. Thus, at every transmission of the same data the receiver gains extra information. Several variants of these combining methods also exist. For example, in partial chase combining only a subset of the bits in the main transmission are retransmitted. In partial incremental redundancy, the systematic bits are always included so that each retransmission is self-decodable.

In addition to improving efficiency and robustness the above principles can be used to avoid mode switches associated with configuring each communication device to receive only one transmission mode and/or enable application of more than only one transmission mode in a cell at a time.

A possible use scenario for this is emergency voice or voice and video group communications.

It is noted that whilst embodiments have been described in relation to LTE, similar principles can be applied to any other communication system or indeed to further developments with LTE. Also, instead of transmission by fixed base stations transmissions may be provided by a non-stationary device such as a mobile station acting as a broadcasting element. For example, this may be the case in application where no fixed equipment provided but a communication system is provided by means of a plurality of user equipment, for example in adhoc networks or other mobile stations that can act as a base or relay station. Therefore, although certain embodiments were described above by way of example with reference to certain exemplifying architectures for wireless networks, technologies and standards, embodiments may be applied to any other suitable forms of communication systems than those illustrated and described herein.

The required data processing apparatus and functions may be provided by means of one or more data processors. The described functions may be provided by separate processors or by an integrated processor. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non-limiting examples. The data processing may be distributed across several data processing modules. A data processor may be provided by means of, for example, at least one chip. Appropriate memory capacity can also be provided in the relevant devices. The memory or memories may be of any type suitable to the local technical environment and may be implemented using any suitable data storage technology, such as semiconductor based memory devices, magnetic memory devices and systems, optical memory devices and systems, fixed memory and removable memory.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof. The software may be stored on such physical media as memory chips, or memory blocks implemented within the processor, magnetic media such as hard disk or floppy disks, and optical media such as for example DVD and the data variants thereof, CD.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the spirit and scope of this invention as defined in the appended claims. Indeed there is a further embodiment comprising a combination of one or more of any of the other embodiments previously discussed.

1. A method of communicating user plane data by a group service, the method comprising
causing cell-specific broadcasting of said user plane data in a cell, and
unicasting in parallel the same user plane data to at least one communication device in the cell.

2. A method of receiving user plane data by a communication device participating a group service, the method comprising
receiving cell-specific broadcasting of said user plane data in a cell,
receiving in parallel unicasting of said user plane data, and
combining the broadcast and unicast user plane data.

3. A method according to claim 1, comprising at least one of selective combining and soft combining of broadcast and unicast user plane data.

4. A method according to claim 1, wherein the user plane data comprises voice and/or video data.

5. A method according to claim 1, wherein the unicasting is directed to or received by at least one communication device in poor radio conditions.

6. A method according to claim 1, comprising broadcasting the user plane data only in a part of the area of the cell and transmitting said user plane data to devices in other area of the cell by the unicasting.

7. A method according to claim 1, comprising configuring at least one communication device by a radio resource control procedure to monitor a physical downlink control channel for communications associated with the cell-specific broadcasting based on a radio network temporary identifier allocated for the group service, and
monitor the physical downlink control channel for downlink allocations associated with the service based on a cell and device specific radio network temporary identifier.

8. A method according to claim 1, comprising continuously determining whether to transmit a given data packet of said user plane data to a given communication device by the cell-specific broadcasting and/or by the unicasting based on information of at least one of the number of communication devices in the cell, channel quality reported from the cell and error correction mechanism feedback in control of said communication of user plane data and/or at least one report from at least one communication device.

9. A method according to claim 1, wherein an activation command or deactivation command is used to control monitoring of a radio network temporary identifier allocated for the group service.

10. A method according to claim 1, comprising transmitting or receiving the cell-specific broadcasting based on a cell-specific discontinuous reception scheme.

11. A method according to claim 2, comprising determining by the communication device that decoding of a data packet corresponding to a detected radio network temporary identifier associated with the cell-specific broadcasting was unsuccessful, and signalling a negative acknowledgement in response to said determining of unsuccessful decoding of the broadcast data packet.

12. A method according to claim 11, wherein at least two communication devices signal negative acknowledgements such that a stronger negative acknowledgement signal is generated compared to a single negative acknowledgement.

13. A control apparatus for a cell, the control apparatus comprising at least one processor, and at least one memory including computer program code, wherein the at least one memory and the computer program code are configured, with the at least one processor, to cause
cell-specific broadcasting of user plane data for a group service in a cell, and
parallel unicasting of the same user plane data to at least one communication device in the cell.

14. A control apparatus for a communication device, the control apparatus comprising at least one processor, and at least one memory including computer program code, wherein the at least one memory and the computer program code are configured, with the at least one processor, to cause
reception of cell-specific broadcasting of user plane data for a group service in a cell,
parallel reception of unicasting of the same user plane data, and
combining the broadcast and unicast user plane data.

15-25. (canceled)

26. A method according to claim 2, comprising at least one of selective combining and soft combining of broadcast and unicast user plane data.

27. A method according to claim 2, wherein the user plane data comprises voice and/or video data.

28. A method according to claim 2, comprising configuring at least one communication device by a radio resource control procedure to
monitor a physical downlink control channel for communications associated with the cell-specific broadcasting based on a radio network temporary identifier allocated for the group service, and
monitor the physical downlink control channel for downlink allocations associated with the service based on a cell and device specific radio network temporary identifier.

29. A method according to claim 2, comprising continuously determining whether to transmit a given data packet of said user plane data to a given communication device by the cell-specific broadcasting and/or by the unicasting based on information of at least one of the number of communication devices in the cell, channel quality reported from the cell and error correction mechanism feedback in control of said communication of user plane data and/or at least one report from at least one communication device.

30. A method according to claim 2, wherein an activation command or deactivation command is used to control monitoring of a radio network temporary identifier allocated for the group service.

31. A method according to claim 2, comprising transmitting or receiving the cell-specific broadcasting based on a cell-specific discontinuous reception scheme.
